(19) United States
(12) Patent Application Publication
(10) Pub. No.: US 2004/0067861 A1
(43) Pub. Date: Apr. 8, 2004

(54) Liquid gel automatic dishwashing detergent composition comprising anhydrous solvent

(75) Inventors: Frank William Denome, Cincinnati, OH (US); Leslie Dawn Waits, Cincinnati, OH (US); Elizabeth Ann Alam, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/644,286

(22) Filed: Aug. 20, 2003

Related U.S. Application Data
(60) Provisional application No. 60/404,663, filed on Aug. 20, 2002.

(51) Int. Cl. C11D 1/00

(52) U.S. Cl. 510/221

(57) ABSTRACT

An organic solvent composition suitable for use in automatic dishwashing comprising: (a) from about 10% to about 80%, by weight, a non-aqueous organic solvent system; (b) from about 5% to about 70%, by weight, sodium tripolyphosphate (STPP); (c) at least about 0.00005%, by weight, a water-soluble dye; (d) an effective amount of water; (e) from about 0.5% to about 1%, by weight, a thickener; and (f) optionally an adjunct ingredient; wherein said composition is in the form of an anhydrous liquid gel; wherein the yield value of said composition has a range of from about 5 to about 35; and wherein the effective amount of water is calculated by the following formula: STPP+6H2O→STPP*6H2O.

### CROSS REFERENCE TO RELATED APPLICATION

This application claims the benefit of the filing date of U.S. Patent Application No. 60/404,663, filed Aug. 20, 2002.

### TECHNICAL FIELD

The present invention is in the field of dishwashing, in particular it relates to dishwashing and automatic dishwashing products, auxiliaries and methods suitable for cleaning soiled dishware, glassware, cookware and tableware.

### BACKGROUND OF THE INVENTION

The following references relate to the use of solvents in the automatic dishwashing context: JP-A-10,017,900; JP-A-11,117,000; and WO 02/16222 A1. For example, JP-A-10,017,900 discloses an automatic dishwashing auxiliary composition comprising non-ionic low foaming surfactant, organic solvent and water. The composition allegedly delivers detergency and drying benefits. JP-A-11,117,000 discloses a cleaning assistant composition for automatic dishwashing machines comprising surfactant, organic high-molecular polyelectrolyte, water-soluble solvent and water. WO 02/16222 A1 discloses water-soluble containers containing aqueous compositions that can comprise greater than 3% free water, surface active agents, enzymes, co-builder, organic solvents and co-solvents, dyes, and colourants.

The following references relate to the use of non-aqueous solvents in the automatic dishwashing context: U.S. Pat. No. 4,753,748; U.S. Pat. No. 5,094,771; U.S. Pat. No. 5,164,106; U.S. Pat. No. 5,169,553; U.S. Pat. No. 5,240,633; U.S. Pat. No. 5,318,715; U.S. Pat. No. 5,510,048; U.S. Pat. No. 5,527,483; U.S. Pat. No. 5,545,344; U.S. Pat. No. 5,618,465; U.S. Pat. No. 6,228,825 B1; EP. Patent No. 0611206; and WO 00/75272. For example, U.S. Pat. No. 4,753,748 discloses concentrated, stable, non-settling liquid detergent compositions comprising sodium tripolyphosphate and a water content of about 1%. U.S. Pat. No. 6,228,825 B1 discloses a non-aqueous liquid automatic dishwashing composition disposed in a water-soluble package comprising an organic solvent, an alkali metal phosphate builder salt, a non-ionic surfactant, a silicate, an alkali metal non-phosphate builder salt, and an antiredeposiiton agent. The composition delivers a dosable composition.

The problem with non-aqueous solvent compositions is that when these compositions are placed in water-soluble pouches for use in automatic dishwashing applications, the pouches tend to swell during storage. This is believed to be due mainly to moisture uptake by the anhydrous solvent composition via mass transport through the pores of the pouch. Consequently, the water-soluble pouches become swollen and tight to the touch. Their appearance and feel is not appealing to consumers. Furthermore, the types of dyes, pigments and colorants that are generally available for non-aqueous solvent compositions are generally limited to water insoluble dyes, pigments and colorants which tend to limit the color selection of the non-aqueous solvent compositions to drab coloration which also makes the water-soluble pouches less appealing to consumers. Thus, there is a need for pouched products containing anhydrous solvents that avoid excessive pouch swelling. There is also a need for automatic dishwashing cleaning products comprising anhydrous solvent compositions in water-soluble pouches that provide more pleasing color aesthetics.

Therefore, it is desirable to provide a liquid gel anhydrous organic solvent composition that minimizes excessive pouch swelling and is pleasing to the touch, while at the same time, provides superior product color aesthetics to the consumer by controlling the free water content of the composition by using hydrated sodium tripolyphosphate and selecting pleasing water-soluble dyes.

### SUMMARY OF THE INVENTION

The present invention provides a liquid gel anhydrous organic solvent composition comprising sodium tripolyphosphate hexahydrate to control the free water content of the composition which allows the use of water-soluble dyes and reduces the effect of pouch swelling.

In one aspect of the present invention, an organic solvent composition suitable for use in automatic dishwashing is provided. In one non-limiting embodiment, the composition comprises: (a) from about 10% to about 80%, by weight, a non-aqueous organic solvent system; (b) from about 5% to about 70%, by weight, sodium tripolyphosphate (STPP); (c) at least about 0.00005%, by weight, a water-soluble dye; (d) an effective amount of water; (e) from about 0.5% to about 1%, by weight, a thickener; and (f) optionally an adjunct ingredient; wherein the composition is in the form of an anhydrous liquid gel; wherein the yield value of the composition has a range of from about 5 to about 35, preferably from about 10 to about 20, more preferably from about 12 to about 17, most preferably about 15; wherein the effective amount of water is calculated by the following formula: STPP+6H2O→STPP*6H2O, and wherein the “STPP*6H2O” represents sodium tripolyphosphate hexahydrate.

In another aspect of the present invention, a method of cleaning soiled tableware in an automatic dishwashing machine is provided. In one non-limiting embodiment, the method comprises the step of washing the tableware in the presence of the organic solvent composition described above.

The following description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The present invention is not intended to be limited to the embodiments shown. Thus, since the following specific embodiments of the present invention are intended only to exemplify, but in no way limit, the operation of the present invention, the present invention is to be accorded the widest scope consistent with the principles, features and teachings disclosed herein.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document can be not to be construed as an admission that it can be prior art with respect to the present invention.

### DETAILED DESCRIPTION OF THE INVENTION

Definitions

“Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362).

“Detergent enzyme”, as used herein, means any enzyme having a cleaning, stain removing or otherwise beneficial effect in an organic solvent composition.

“Dishcare agent” means any type of composition or automatic dishwashing detergent additive that provides protective benefits to tableware during cleaning. Dishcare agents can include, but are not limited to, anti-corrosive agents, anti-tarnish agents, silvercare agents, metal care agents, and mixtures thereof.

“Tableware” means any type of dishware, glassware, cookware, and/or silverware, including, but not limited to, those made from glass, plastic, ceramic, metal, wood, porcelain, etc., as well as, any type of silverware which includes all types made from metal, plastic, wood, glass, ceramic, porcelain, etc. Tableware can include, but is not limited to, cooking and eating utensils, dishes, cups, bowls, glasses, silverware, pots, pans, etc.

### Organic Solvent Composition

Organic Solvent System

The cleaning of tableware can be carried out by the use of one or more organic solvent compositions (wherein “solvent composition” is understood to comprise the organic solvent system and optional additional active ingredients and diluents) and one or more automatic dishwashing detergent compositions. The organic solvent composition can be built, unbuilt or generally unbuilt. By “generally unbuilt” is meant that the composition contains less than about 5% by weight of detergency co-builder.

A broad range of organic solvents are suitable for use herein but preferably the organic solvent is selected from alcohols, amines, esters, glycol ethers, glycols, terpenes, and mixtures thereof. The organic solvent system is preferably formulated to meet the constraints on volatile solvent components and in highly preferred, non-limiting embodiments the organic solvent system will contain from about 10% to about 80%, preferably from about 20% to about 70%, and more preferably from about 30% to about 50% of solvent components having a vapor pressure above about 0.1 mm Hg at 25° C. at atmospheric pressure. In highly preferred, non-limiting embodiments, the solvent is essentially free (contains less than about 5% by weight) of solvent components having a boiling point below about 150° C., flash point below about 100° C. or a vapor pressure above about 1 mm Hg at 25° C. at atmospheric pressure.

The organic solvents should be selected so as to be compatible with the tableware, as well as with, the different parts of an automatic dishwashing machine. The individual organic solvents used herein generally have a boiling point above about 150° C., flash point above about 100° C. and vapor pressure below about 1 mm Hg, preferably below 0.1 mm Hg at 25° C. at atmospheric pressure.

Hansen solubility parameters were developed to characterize solvents for the purpose of comparison. Each of the three parameters (i.e., dispersion, polar and hydrogen bonding) represents a different characteristic of solvency. In combination, the three parameters are a measure of the overall strength and selectivity of a solvent. The above Hansen solubility parameter ranges identify solvents that are good solvents for a wide range of substances and also exhibit a degree of solubility in liquid carbon dioxide. The Total Hansen solubility parameter, which is the square root of the sum of the squares of the three parameters mentioned previously, provides a more general description of the solvency of the organic solvents.

In terms of solvent parameters, the organic solvent can be selected from (a) polar, hydrogen-bonding solvents having a Hansen solubility parameter of at least 20 (Mpa)^{1/2}, a polarity parameter of at least 7 (Mpa)^{1/2}, preferably at least 12 (Mpa)^{1/2} and a hydrogen bonding parameter of at least 10 (Mpa)^{1/2}; (b) polar non-hydrogen bonding solvents having a Hansen solubility parameter of at least 20 (Mpa)^{1/2}, a polarity parameter of at least 7 (Mpa)^{1/2}, preferably at least 12 (Mpa)^{1/2} and a hydrogen bonding parameter of less than 10 (Mpa)^{1/2}; (c) amphiphilic solvents having a Hansen solubility parameter below 20 (Mpa)^{1/2}, a polarity parameter of at least 7 (Mpa)^{1/2} and a hydrogen bonding parameter of at least 10 (Mpa)^{1/2}; and (d) non-polar solvents having a polarity parameter below 7 (Mpa)^{1/2} and a hydrogen bonding parameter below 10 (Mpa)^{1/2}, and mixtures thereof.

For example, solvents that can be used herein include: i) alcohols, such as benzyl alcohol, 1,4-cyclohexanedimethanol, 2-ethyl-1-hexanol, furfuryl alcohol, 1,2-hexanediol and other similar materials; ii) amines, such as alkanolamines (e.g. primary alkanolamines: monoethanolamine, monoisopropanolamine, diethylethanolamine, ethyl diethanolamine; secondary alkanolamines: diethanolamine, diisopropanolamine, 2-(methylamino)ethanol; ternary alkanolamines: triethanolamine, triisopropanolamine); alkylamines (e.g. primary alkylamines: monomethylamine, monoethylamine, monopropylamine, monobutylamine, monopentylamine, cyclohexylamine), secondary alkylamines: (dimethylamine), alkylene amines (primary alkylene amines: ethylenediamine, propylenediamine) and other similar materials; iii) esters, such as ethyl lactate, methyl ester, ethyl acetoacetate, ethylene glycol monobutyl ether acetate, diethylene glycol monoethyl ether acetate, diethylene glycol monobutyl ether acetate and other similar materials; iv) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; v) glycols, such as propylene glycol, diethylene glycol, hexylene glycol (2-methyl-2, 4 pentanediol), triethylene glycol, composition and dipropylene glycol and other similar materials; and mixtures thereof.

The organic solvent system is preferably selected from i) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; and ii) glycols, such as propylene glycol, diethylene glycol, hexylene glycol (2-methyl-2, 4 pentanediol), triethylene glycol, composition and dipropylene glycol and other similar materials; and mixtures thereof.

In one non-limiting embodiment, the automatic dishwashing detergent composition is in the form of a liquid gel comprising from about 10% to about 80%, preferably from about 20% to about 70%, most preferably from about 30% to about 50%, by weight, of a non-aqueous organic solvent, preferably dipropylene glycol.

Hydratable Builders

Phosphate Builder

Phosphate builders include, but are not limited to, the alkali metal, ammonium and alkanolammonium salts of polyphosphates (exemplified by the tripolyphosphates, pyrophosphates, and glassy polymeric meta-phosphates). Phosphate builder sources are described in detail in Kirk Othmer, 3rd Edition, Vol. 17, pp. 426-472 and in “Advanced Inorganic Chemistry” by Cotton and Wilkinson, pp. 394-400 (John Wiley and Sons, Inc.; 1972).

A preferred phosphate builder salt is sodium tripolyphosphate (STPP). The STPP can be a blend of anhydrous STPP and a small amount of STPP hexahydrate such that the chemically bound water content corresponds to six H₂O molecules per pentasodium tripolyphosphate molecule. Such STPP may be produced by treating anhydrous STPP with a limited amount of water. The presence of the hexahydrate slows down the rapid rate of solution of the STPP in the wash bath and inhibits caking. One suitable STPP is sold under the name THERMPHOS™ NW. The particles size of the THERMPHOS™ NW STPP, as supplied, is usually averages 200 microns with the largest particles being 400 microns.

One aspect of the invention relates to the use of hydrated STPP. The hydrated STPP used in one non-limiting embodiment of the present invention is preferably the hexahydrate form. Hydrated STPP is commercially available, however, it is expensive and generally not completely hydrated (e.g. it is only partially hydrated). A separate rehydration stage is generally required as a separate step in the process. Thus use of anhydrous STPP or partially hydrated STPP in the rehydration step is preferred. The effective amount of water in the organic solvent composition is determined by the amount of hexahydrate generated. The uptake of moisture through the water-soluble pouch containing the organic solvent composition is related to the amount of water present in the composition.

Since sodium tripolyphosphate hexahydrate is less readily soluble in water than potassium tripolyphosphate, the use of sodium tripolyphosphate hexahydrate is preferred over potassium tripolyphosphate. Sodium tripolyphosphate hexahydrate provides a heterogeneous character to the resulting gels giving a higher structural viscosity. This so-called high structural viscosity decreases considerably at relatively high spindle speeds and increases considerably at low spindle speeds. The viscosity measurements were carried out using a Contraves™ rotational cup & bob viscosimeter. The viscosities of the cleaning agents used in accordance with the invention extend up to 25,000 Pa.s, @ 1 s-1 as measured at a temperature of 25° C.

In one non-limiting embodiment of the present invention, sodium tripolyphosphate is typically present at a level of from about 5% to about 70% by weight, preferably from about 7% to about 50% by weight, most preferably from about 10% to about 30% by weight of composition.

Citrate Builder

Like phosphate builders, citrate builders are classified as sequestering builders and dissolve rapidly to form complexes with hardness ion. Although phosphate forms much more stable complexes with hardness ions, in regions where phosphate builders cannot be used, citrate builders are generally practiced.

Citrate builders include, but are not limited to, potassium and sodium salts of citrate. A preferred citrate builder is sodium citrate. One aspect of the invention relates to the use of hydrated sodium citrate, such that the chemically bound water content corresponds to two H₂O per sodium citrate molecule.

The hydrated sodium citrate used in one non-limiting embodiment of the present invention is preferably the dihydrate form. Sodium citrate dihydrate, like STPP hexahydrate, provides a heterogeneous character to the resulting gels giving a higher structural viscosity. Since sodium citrate dihydrate is less soluble in water than the potassium salt and does not form a monohydrate like potassium citrate, the sodium salt is preferred over the potassium salt.

In one non-limiting embodiment of the present invention, sodium citrate is typically present at a level of from about 5% to about 70% by weight, preferably from about 7% to about 50% by weight, most preferably from about 10% to about 30% by weight of composition.

Effective Amount of Water

The effective amount of water, preferably deionized water, in the anhydrous organic solvent composition of the present invention is determined by the amount of hydrated builder species to be generated. The uptake of moisture through the water-soluble pouch containing the anhydrous organic solvent composition is related to the amount of water present in the composition itself. For example, anhydrous solvent compositions generally exhibit a higher uptake of moisture than aqueous solvent compositions in water-soluble pouches. Without being bound by any particular theory, it is believed that water transportation through the pouch wall can be driven by a high gradient due to the presence of the source of alkalinity (e.g. carbonate).

For example, the effective amount of water for the phosphate builder, STPP, is calculated by the following chemical equation: STPP+6H2O→STPP*6H2O, wherein the “STPP*6H2O” represents sodium tripolyphosphate hexahydrate. For example, if the composition contains 22.37% STPP, the total amount of water needed to convert the STPP to 100% STPP*6H2O is 6.57%. Note that some water will come from the stock material. If the stock material is 20% active, then 2.96% water is derived from the stock material alone. The balance 3.61% water will be added to the composition to deliver a product yield value of from about 5 to about 10, generally about 7.

Moisture Content

Comprehensive sets of analyses were completed on products comprising fully anhydrous organic solvent compositions. This anhydrous product was pouched in MONOSOL® 8630 PVA film on the vertical heat sealer, placed in both sealed and un-sealed plastic tubs with snap on lids, and 100 pouches were placed in the following environments: 80° F./80% RH, 80° F./15% RH, and Ambient (˜70° F./26% RH). At the increments of 1, 2, 4, and 6 weeks the following characteristics were assessed: moisture content/pick-up, enzyme activity, pouch weight, pouch feel, phase stability, and relative pouch dissolution. Additionally girth-height measurements of the pouches were taken with modified calipers to obtain an indirect reading of the volume changes due to moisture pickup associated with the different environments under which the pouches were subjected. In addition, temperature and humidity were tracked throughout the experiment via use of HOBO® data loggers.

As was seen in Table I below, the pouches at 80% relative humidity showed the largest average gain in weight (and >30% girth-height increase) after 6 weeks in unsealed tubs. Comparison of the results indicates that humidity is a large driver of the weight change. Higher humidity allows for more water pick-up, resulting in excessive pouch swelling and consumer dissatisfaction. Enzyme activities were also unacceptable at the higher humidity.

TABLE I

| | Ambient | | |
|---|---|---|---|
| | 70° F., 26% Rel. | 80° F., 15% Rel. | 80° F., 80% Rel. |
| | Humidity | Humidity | Humidity |
| Week | % Weight Change | % Weight Change | % Weight Change |
| 1 | 0.397% | 0.06% | 1.20% |
| 2 | 0.529% | 0.005% | 2.11% |
| 4 | 1.15% | 0.44% | 3.96% |
| 6 | 1.52% | 1.49% | 5.96% |

It has been surprisingly found that the present invention shows significantly less weight gain over the same period than the anhydrous compositions tested above. This is believed to be largely due to the use of hydrated STPP in the process. It is believed that the co-builder, picks up any free water and thus minimizes the swelling caused by excessive moisture uptake during unsealed storage.

Water-Soluble Dye

Readily water-soluble dyes or fluorescent brighteners are to be understood as meaning dyes or fluorescent brighteners having a solubility in water of >100 g/125° C. Suitable water-soluble dyes are primarily textile dyes of all kinds of chemical classes. They are for example anionic dyes, such as nitro, aminoketone, ketone-imine, methine, nitrodiphenylamine, quinoline, aminonaphthaquinone or coumarin dyes or even acid dyes based on fustic extract, in particular acid anthraquinone and azo dyes, such as monoazo and disazo dyes. These dyes contain at least one anionic water-solubilizing group, for example a carboxyl or in particular a sulfo group. The dyes are generally in their salt form, for example in the form of the lithium, sodium, potassium or ammonium salt. Also possible are basic, i.e. cationic, dyes and stilbene dyes. Examples thereof are the halides, sulfates, methosulfates or metal halide salts, for example tetrachlorozincates, of azo dyes, such as monoazo, disazo and polyazo dyes, and of anthraquinone dyes, phthalocyanine dyes, diphenylmethane and triarylmethane dyes, methine, polymethine and azomethine dyes and of thiazole, ketone-amine, acridine, cyanine, nitro, quinoline, benzimidazole, xanthene, azine, oxazine and thiazine dyes. These basic dyes are commercially available under a wide variety of different names.

In one non-limiting embodiment of the present invention, the organic solvent composition comprises at least 0.00005%, preferably at least 0.0005%, most preferably at least 0.001% by weight of the total composition a water-soluble dye. Preferred water-soluble dyes can be selected from the group consisting of azo dye, stilbene dye, phthalocyanine dye, triphenodioxazine dye, formazan dye, anthraquinone dye, and mixtures thereof.

Thickener

Suitable thickening agents include inorganic clays (e.g. LAPONITE®, aluminium silicate, bentonite, fumed silica), natural gum and cellulosic type thickeners. The preferred clay thickening agent can be either naturally occurring or synthetic. Preferred synthetic clays include the synthetic smectite-type clay sold under the trademark LAPONITE® by Southern Clay Products, Inc. Particularly useful are gel-forming grades such as LAPONITE RD® and sol forming grades such as LAPONITE RDS®. Natural occurring clays include some smectite and attapulgite clays. Mixtures of clays and polymeric thickeners are also suitable for use herein.

Suitable natural gum thickeners include, for example, xanthan gum, locust bean gum, guar gum, and the like.

Preferred thickeners are the cellulosic type thickeners: hydroxyethyl and hydroxymethyl cellulose (ETHOCEL® and METHOCEL® available from Dow Chemical) can also be used. The compositions preferably are in liquid gel-form and contain a thickener such as methylcellulose or other nonionic cellulosic thickener.

### Adjunct Ingredients

Other Organic Solvents

The present invention includes the use of solvent compositions as additives for conventional automatic dishwashing detergent compositions. It also includes multi-component dishwashing products containing purpose-designated combination of solvent compositions and dishwashing detergent compositions. The invention also includes so called “all-in-one” detergent and cleaning products having both an alkaline detergent and a solvent functionality. In the case of additive and multi-component products, the invention does not require the two compositions to be in the same physical form. The organic solvent composition can be in any physical form, e.g. liquid, paste, cream, gel, liquid gels and similarly the automatic dishwashing detergent composition can be in any of these forms. Preferably, however, both compositions are in the form of liquids and/or gels. The compositions used herein can be dispensed from any suitable device, such as bottles (pump assisted bottles, squeeze bottles), paste dispensers, capsules, multi-compartment bottles, multi-compartment capsules, pouches, and multi-compartment pouches. Pouches and multi-compartment pouches are preferred. The solvent compositions herein can comprise one or more organic solvents and can additionally comprise surfactant, bleach, enzyme, enzyme stabilising components, etc.

The automatic dishwashing detergent (hereinafter “ADD”) compositions herein can comprise traditional detergency components and can also comprise organic solvents having a cleaning function and organic solvents having a carrier or diluent function or some other specialised function. The compositions will generally be built and comprise one or more detergent active components which may be selected from colorants, bleaching agents, surfactants, alkalinity sources, enzymes, thickeners (in the case of liquid, paste, cream or gel compositions), anti-corrosion agents (e.g. sodium silicate), hydrotropes (e.g. sodium cumene sulfate) and disrupting agents. Highly preferred detergent components include a builder compound, an alkalinity source, a surfactant, an enzyme and a bleaching agent.

For example, liquid, gel or liquid gel ADD compositions of the present invention can contain water and other volatile solvents as carriers. Low quantities of low molecular weight primary or secondary alcohols such as methanol, ethanol, propanol and isopropanol can be used in the liquid detergent of the present invention. Other suitable carrier solvents used in low quantities includes glycerol, propylene glycol, ethylene glycol, 1,2-propanediol, sorbitol, and mixtures thereof.

Unless otherwise specified, the components described hereinbelow can be incorporated either in the organic solvent compositions and/or the ADD compositions.

Wetting Agent

The effect of the organic solvent system can be further improved by the addition of certain wetting agents. Preferably, the organic solvent system is used in conjunction with a wetting agent effective in lowering the surface tension of the organic solvent system, preferably to at least 1 mN/m less than that of the wetting agent, the wetting agent preferably being selected from organic surfactants having a surface tension less than about 30 mN/m, more preferably less than about 28 mN/m and specially less than about 26 mN/m. Preferred wetting agents for use herein are silicone polyether copolymers, especially silicone poly(alkyleneoxide) copolymers wherein alkylene is selected from ethylene, propylene, and mixtures thereof.

Source of Alkalinity

To provide an alkaline pH, the organic solvent composition comprises an alkalinity source. Generally, the alkalinity source raises the pH of the organic solvent composition to at least 10.0 in a 1 wt-% aqueous solution and preferably to a range of from about 10.5 to 14. Such pH is sufficient for soil removal and sediment breakdown when the chemical is placed in use and further facilitates the rapid dispersion of soils. The general character of the alkalinity source is limited only to those chemical compositions which have a substantial aqueous solubility. Exemplary alkalinity sources include an alkali metal silicate, hydroxide, phosphate, or carbonate. The alkalinity source can include an alkali metal hydroxide including sodium hydroxide, potassium hydroxide, lithium hydroxide, etc.

Mixtures of these hydroxide species can also be used. Alkaline metal silicates can also act as a source of alkalinity for the detergents of the invention. Useful alkaline metal silicates correspond with the general formula (M₂O:SiO₂) wherein for each mole of M₂O there is less than one mole of SiO₂. Preferably for each mole of SiO₂ there is from about 0.2 to about 100 moles of M₂O wherein M comprises sodium and/or potassium. Preferred sources of alkalinity are alkaline metal orthosilicate, alkaline metal metasilicate, and other well known detergent silicate materials.

The alkalinity source can include an alkali metal carbonate. Alkali metal carbonates that may be used in the invention include sodium carbonate, potassium carbonate, sodium and/or potassium bicarbonate or sesquicarbonate, silicate, and mixtures thereof among others. Preferred carbonates include sodium and potassium carbonates. These sources of alkalinity can be used the detergents of the invention at concentrations about 0 wt-% to about 50 wt-%, preferably from about 5 wt-% to about 40 wt-%, and most preferably from about 10 wt-% to about 30 wt-%.

Co-Builder

All builders suitable for use in ADD compositions are suitable herein as co-builders. The co-builder of the present invention is typically present at a level of from about 1% to about 80% by weight, preferably from about 10% to about 70% by weight, most preferably from about 20% to about 60% by weight of composition.

For example, the present invention may include, but are not limited to, the following builders: amorphous sodium silicates, aluminosilicates, magnesioaluminosiliates, alkali metal, phosphates, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulfates, citrate, zeolite and/or layered silicate, alkaline earth and alkali metal carbonates, polycarboxylate compounds, ether hydroxypolycarboxylates, copolymers of maleic anhydride with ethylene or vinyl methyl ether, 1, 3, 5-trihydroxy benzene-2, 4, 6-trisulphonic acid, and carboxymethyloxysuccinic acid, the various alkali metal, ammonium and substituted ammonium salts of polyacetic acids, such as ethylenediaminetetraacetic acid and nitrilotriacetic acid, as well as polycarboxylates, such as mellitic acid, succinic acid, oxydisuccinic acid, polymaleic acid, benzene 1,3,5-tricarboxylic acid, carboxymethyloxysuccinic acid, and soluble salts thereof, and citrate co-builders, such as citric acid and soluble salts thereof (particularly sodium salt).

In one non-limiting embodiment of the present invention, the co-builder is selected from the group consisting of phosphate, phosphate oligomers or polymers and salts thereof, silicate, silicate oligomers or polymers and salts thereof, alurninosilicates, magnesioaluminosiliates, citrate, and mixtures thereof.

Enzyme

Preferred enzymes are hydrolases such as proteases, amylases and lipases. Highly preferred for automatic dishwashing are amylases and/or proteases, including both current commercially available types and improved types which, though more bleach compatible, have a remaining degree of bleach deactivation susceptibility.

The organic solvent compositions herein comprise one or more enzymes. If only one enzyme is used, it is preferably an amyolytic enzyme. Highly preferred for automatic dishwashing is a mixture of proteolytic enzymes and amyloytic enzymes. More generally, the enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, co-builders, etc. In this respect bacterial or fungal enzymes are preferred, such as bacterial amylases and proteases, and fungal cellulases.

Enzymes are normally incorporated in the instant detergent compositions at levels sufficient to provide a “cleaning-effective amount”. The term “cleaning-effective amount” refers to any amount capable of producing a cleaning, stain removal or soil removal effect on substrates such as fabrics, dishware and the like. Since enzymes are catalytic materials, such amounts may be very small.

In practical terms for current commercial preparations, typical amounts are up to about 5 mg by weight, more typically about 0.01 mg to about 3 mg, of active enzyme per gram of the composition. Protease enzymes are usually present in such commercial preparations at levels sufficient to provide from 0.005 to 0.1 Anson units (AU) of activity per gram of composition, preferably 0.01%-1% by weight of a commercial enzyme preparation.

Enzyme-containing compositions, especially liquid, liquid gel and gel compositions, herein may comprise from about 0.0001% to about 10%, preferably from about 0.005% to about 8%, most preferably from about 0.01% to about 6%, by weight of an enzyme stabilizing system. The enzyme stabilizing system can be any stabilizing system which is compatible with the detersive enzyme. Such stabilizing systems can comprise calcium ion, boric acid, propylene glycol, short chain carboxylic acid, boronic acid, and mixtures thereof.

For automatic dishwashing purposes, it may be desirable to increase the active enzyme content of the commercial preparations, in order to minimize the total amount of non-catalytically active materials delivered and thereby improve spotting/filming results.

In a non-limiting embodiment of the present invention, the organic solvent composition comprises from about 0.0001% to about 2% by weight of the total composition, an enzyme stabilizing system.

Surfactant

In compositions and methods of the present invention for use in automatic dishwashing the detergent surfactant is preferably low foaming by itself or in combination with other components (i.e. suds suppressers). In compositions and methods of the present invention for use in cleaning soiled tableware prior to dishwashing, the detergent surfactant is preferably foamable in direct application but low foaming in automatic dishwashing use.

Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants, and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (for example, amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874.

Surfactants are typically present at a level of from about 0.2% to about 30% by weight, more preferably from about 0.5% to about 10% by weight, most preferably from about 1% to about 5% by weight of composition.

In one non-limiting embodiment of the present invention, the organic solvent composition comprises from about 0% to about 30% by weight, a surfactant selected from the group consisting of anionic surfactants, cationic surfactants, nonionic surfactants, amphoteric surfactants, ampholytic surfactants, zwitterionic surfactants, and mixtures thereof. In another non-limiting embodiment of the present invention, the surfactant is amine oxide at a level of about 0.5% to about 20%, by weight.

Suds Suppressor

Preferred surfactants for use herein are low foaming and include low cloud point nonionic surfactants and mixtures of higher foaming surfactants with low cloud point nonionic surfactants which act as suds suppressors therein (see WO-93/08876 and EP-A-0705324).

Typical low cloud point nonionic surfactants which act as suds suppressors include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., Olin Corporation's POLY-TERGENT® SLF18) and epoxy-capped poly(oxyalkylated) alcohols (e.g., Olin Corporation's POLY-TERGENT® SLF18B series of nonionics, as described, for example, in U.S. Pat. No. 5,576,281).

Preferred low cloud point surfactants are the ether-capped poly (oxyalkylated) suds suppressor having the formula:

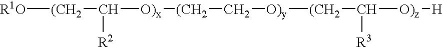

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:

(i) a 4 to 8 membered substituted, or unsubstituted heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

Suds suppressors are typically present at a level of from about 0.2% to about 30% by weight, more preferably from about 0.5% to about 10% by weight, most preferably from about 1% to about 5% by weight of composition.

Bleaching System

In one non-limiting embodiment of the present invention a bleaching system comprises a bleach, a bleach catalyst, a bleach activator, and mixtures thereof. In a non-limiting embodiment of the present invention, the organic solvent composition comprises a bleaching system in an amount from about 0% to about 15%, preferably from about 1% to about 10%, more preferably from about 2% to about 6% by weight of the total composition.

Bleaching agents suitable herein include chlorine and oxygen bleaches, especially inorganic perhydrate salts such as sodium perborate mono-and tetrahydrates and sodium percarbonate optionally coated to provide controlled rate of release (see, for example, GB-A-1466799 on sulfate/carbonate coatings), preformed organic peroxyacids, and mixtures thereof with organic peroxyacid bleach precursors and/or transition metal-containing bleach catalysts (especially manganese or cobalt).

Peroxygen bleaching compounds can be any peroxide source, and is preferably a member selected from the group consisting of sodium perborate monohydrate, sodium perborate tetrahydrate, sodium pyrophosphate peroxyhydrate, urea peroxyhydrate, sodium percarbo-nate, sodium peroxide and mixtures thereof. Highly preferred peroxygen bleaching compounds are selected from the group consisting of sodium perborate monohydrate, sodium perborate tetrahydrate, sodium percarbonate and mixtures thereof.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410) at levels from 0% to about 10.%, by weight; preferably from 0.1% to 1.0%.

Typical bleach activators preferred for use herein include peroxyacid bleach precursors, precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807) at levels from 0% to about 10.%, by weight; preferably from 0.1% to 1.0%.

Other bleach activators include to substituted benzoyl caprolactam bleach activators and their use in bleaching systems and laundry detergents. The substituted benzoyl caprolactams have the formula:

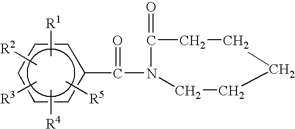

wherein R¹, R², R³, R⁴, and R⁵ contain from 1 to 12 carbon atoms, preferably from 1 to 6 carbon atoms and are members selected from the group consisting of H, halogen, alkyl, alkoxy, alkoxyaryl, alkaryl, alkaryloxy, and members having the structure:

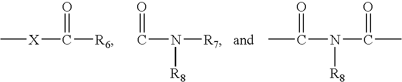

wherein R₆ is selected from the group consisting of H, alkyl, alkaryl, alkoxy, alkoxyaryl, alkaryloxy, and aminoalkyl; X is O, NH, or NR₇, wherein R₇ is H or a C₁-C₄ alkyl group; and R₈ is an alkyl, cycloalkyl, or aryl group containing from 3 to 11 carbon atoms; provided that at least one R substituent is not H.

In a non-limiting embodiment, R¹, R², R³, and R⁴ are H and R⁵ is selected from the group consisting of methyl, methoxy, ethyl, ethoxy, propyl, propoxy, isopropyl, isopropoxy, butyl, tert-butyl, butoxy, tert-butoxy, pentyl, pentoxy, hexyl, hexoxy, Cl, and NO₃. In another preferred embodiment, R¹, R², R³ are H, and R⁴ and R⁵ are members selected from the group consisting of methyl, methoxy, and Cl.

In a non-limiting embodiment of the present invention the bleaching system comprises:

a) from about 0% to about 15% by weight, preferably from about 2% to about 6% by weight, of a peroxygen bleaching compound capable of yielding hydrogen peroxide in an aqueous solution;

b) from about 0% to about 1.0% by weight, of one or more substituted benzoyl caprolactam bleach activators having the formula:

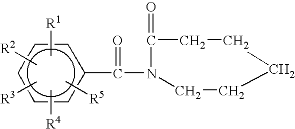

wherein R¹, R², R³, R⁴, and R⁵ are as defined above.

Other Suitable Components

In another embodiment of the present invention, the organic solvent composition can further comprise antiredopsition agents, free radical inhibitors, polymers, soil release agents, anti-filming agents, anti-spotting agents, hydrotropes, germicides, fungicides, color speckles, bleach scavengers, dishcare agents, and mixtures thereof.

The compositions herein can contain a corrosion inhibitor such as organic silver coating agents in levels of from about 0.05% to about 10%, preferably from about 0.1% to about 5% by weight of composition (especially paraffins such as Winog 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Organic polymers having dispersant, anti-redeposition, soil release or other detergency properties can exist in the present invention at levels of from about 0.1% to about 30%, preferably from about 0.5% to about 15%, most preferably from about 1% to about 10% by weight of composition. Preferred anti-redeposition polymers herein include acrylic acid containing polymers such as Sokalan PA30, PA20, PA15, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol, and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta (methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

Other suitable components herein include water-soluble bismuth compounds such as bismuth acetate and bismuth citrate at levels of from about 0.01% to about 5%, enzyme stabilizers such as calcium ion, boric acid, propylene glycol and chlorine bleach scavengers at levels of from about 0.01% to about 6%, lime soap dispersants (see WO-A-93/08877), colorants, optical brighteners, perfumes, fillers and clay.

### Method of Use

The invention can be applied to single-phase “all-in-one” products. According to this aspect, a method of cleaning soiled tableware comprises washing the tableware in an automatic dishwashing machine with an automatic dishwashing detergent composition comprising surfactant (preferably comprising low-foaming nonionic surfactant), detergency co-builder and organic solvent system in levels sufficient to provide a wash liquor concentration of from about 10 ppm to about 1000 ppm surfactant, from about 100 ppm to about 5000 ppm detergency co-builder, and about 100 ppm to about 10,000, preferably from about 500 ppm to about 5000 ppm of organic solvent.

In another embodiment of the invention the organic solvent composition can be in a unit dose form allowing controlled release (for example delayed, sustained, triggered or slow release) of the composition during one or more repeated washing cycles. In preferred unit dose forms, the solvent composition is contained in a single or multi-compartment water-soluble pouch.

### Article of Manufacture

The invention also relates to an article of manufacture comprising (a) a package, (b) instructions for use, and (c) an organic solvent composition suitable for use in automatic dishwashing comprising (i) from about 10% to about 80% by weight of an organic solvent system, ii) from about 5% to about 70% by weight of STPP; at least about 0.00005% by weight of a water-soluble dye; iii) an effective amount of water; iv) optionally, an adjunct ingredient; wherein the composition is in the form of an anhydrous liquid, paste, cream or gel.

Water-Soluble Pouch

It is a feature of the invention that many of the organic solvent systems and compositions of the invention that are optimum for cleaning also demonstrate improved compatibility with partially hydrolysed, water-soluble PVA pouch materials of known construction and type. This is particularly surprising given that many well-known polar/or hydrolysed bonding solvent materials (for example the organoamines) in themselves have low compatibility with PVA materials and present serious issues for product stability.

The organic solvent composition can be in any physical form, e.g. liquid, paste, cream, gel, liquid gels and similarly the automatic dishwashing detergent composition can be in any of these forms. Preferably, however, both compositions are in the form of liquids, liquid gels and/or gels. The compositions used herein can be dispensed from any suitable device, such as bottles (pump assisted bottles, squeeze bottles), paste dispensers, capsules, multi-compartment bottles, multi-compartment capsules, and single- and multi-compartment water-soluble pouches. Single- and multi-compartment water-soluble pouches are preferred. In the case of additive and multi-component products, the invention does not require the two compositions to be in the same physical form.

### EXAMPLES

TABLE II

| | 1 | 2 |
|---|---|---|
| Material | Weight % | Weight % |
| Hydrated Intermediate Powder | | |
| STPP | 22.37 | 29.63 |
| DI Water | 3.61 | 4.78 |
| Finished Product | | |
| Dipropylene Glycol | 38.38 | 0.00 |
| SLF-18 | 4.63 | 4.00 |
| C14 Amine Oxide | 3.70 | 3.00 |
| DI Water | 0.00 | 37.99 |
| G100 Sodium Carbonate | 21.80 | 16.46 |
| Hydrated Intermediate Powder | 25.98 | 34.41 |
| Britesil H2O | 1.41 | 1.41 |
| BHT | 0.00 | 0.10 |
| Methocel OS Thickener | 0.20 | 0.03 |
| Sodium Perborate Monohydrate | 0.00 | 0.00 |
| LiquiBlu 4 Perfume | 0.16 | 0.16 |
| Direct Blue 86 Soln | 0.14 | 0.14 |
| FN3 Enzyme Slurry | 1.60 | 1.39 |
| Natalase Enzyme Prill | 2.00 | 0.91 |
| TOTAL | 100.00 | 100.00 |

What is claimed is:

1. An organic solvent composition suitable for use in automatic dishwashing comprising:
a) from about 10% to about 80%, by weight, a non-aqueous organic solvent system;
b) from about 5% to about 70%, by weight, a hydratable builder;
c) at least about 0.00005%, by weight, a water-soluble dye;
d) an effective amount of water;
e) from about 0.5% to about 1%, by weight, a thickener; and
f) optionally, an adjunct ingredient;
wherein said composition is in the form of an anhydrous liquid gel; wherein the yield value of said composition has a range of from about 5 to about 35; and wherein said water-soluble dye is selected from the group consisting of azo dye, stilbene dye, phthalocyanine dye, triphenodioxazine dye, formazan dye, anthraquinone dye, and mixtures thereof.

2. An organic solvent composition according to claim 1 wherein said organic solvent system is selected from:
a) polar, hydrogen-bonding solvents having a Hansen solubility parameter of at least 20 (Mpa)^{1/2}, a polarity parameter of at least 7 (Mpa)^{1/2}, preferably at least 12 (Mpa)^{1/2} and a hydrogen bonding parameter of at least 10 (Mpa)^{1/2};
b) polar non-hydrogen bonding solvents having a Hansen solubility parameter parameter of at least 20 (Mpa)^{1/2}, a polarity parameter of at least 7 (Mpa)^{1/2}, preferably at least 12 (Mpa)^{1/2} and a hydrogen bonding parameter of less than 10 (Mpa)^{1/2};
c) amphiphilic solvents having a Hansen solubility parameter below 20 (Mpa)^{1/2}, a polarity parameter of at least 7 (Mpa)^{1/2} and a hydrogen bonding parameter of at least 10 (Mpa)^{1/2};
d) non-polar solvents having a polarity parameter below 7 (Mpa)^{1/2} and a hydrogen bonding parameter below 10 (Mpa)^{1/2}; and e) mixtures thereof.

3. An organic solvent composition according to claim 2 wherein said organic solvent system is a solvent selected from the group consisting of glycols and glycol derivatives, glycol ethers, glycol esters, and mixtures thereof.

4. An organic solvent composition according to claim 3 wherein said glycol solvent is dipropylene glycol.

5. An organic solvent composition according to claim 1, wherein said hydratable builder is selected from the group consisting of STPP, sodium citrate, and mixtures thereof.

6. An organic solvent composition according to claim 5, wherein said builder is STPP, and wherein the effective amount of water is calculated by the following formula:
STPP+6H2O→STPP*6H2O.

7. An organic solvent composition according to claim 6, wherein said sodium tripolyphosphate (STPP) comprises from about 7% to about 50% by weight of the total composition.

8. An organic solvent composition according to claim 1, wherein said water-soluble dye comprises at least 0.0005% by weight of the total composition.

9. An organic solvent composition according to claim 1, further comprising from about 0% to about 50% by weight, a source of alkalinity selected from the group consisting of carbonate, silicate, and mixtures thereof.

10. An organic solvent composition according to claim 1, further comprising from about 0% to about 50% by weight a co-builder selected from the group consisting of phosphate, phosphate oligomers or polymers and salts thereof, silicate, silicate oligomers or polymers and salts thereof, aluminosilicates, magnesioaluminosiliates, citrate, and mixtures thereof.

11. An organic solvent composition according to claim 1, further comprising from about 0.0001% to about 2% by weight of the total composition, an enzyme stabilizing system.

12. An organic solvent composition according to claim 1, further comprising from about 0% to about 30% by weight, a surfactant selected from the group consisting of anionic surfactants, cationic surfactants, nonionic surfactants, amphoteric surfactants, ampholytic surfactants, zwitterionic surfactants, and mixtures thereof.

13. An organic solvent composition according to claim 12 wherein said surfactant is amine oxide at a level of about 0.5% to about 20%, by weight.

14. An organic solvent composition according to claim 1, further comprising a bleaching system comprising a bleach, a bleach catalyst, a bleach activator, and mixtures thereof, wherein said bleaching system is at a level of from about 0% to about 15%, by weight.

15. An organic solvent composition according to claim 1, wherein said yield value is from about 10 to about 20.

16. An organic solvent composition according to claim 1, wherein said composition further comprises an additional ingredient selected from the group consisting of antiredopsition agents, free radical inhibitors, wetting agent, polymers, soil release agents, anti-filming agents, anti-spotting agents, suds suppressors, hydrotropes, germicides, fungicides, color speckles, bleach scavengers, dishcare agents, and mixtures thereof.

17. A composition according to claim 1, wherein said liquid gel is packaged in a single- or multi-compartment water-soluble pouch.

18. A method of cleaning soiled tableware in an automatic dishwashing machine, the method comprising the step of washing said tableware in the presence of an organic solvent composition comprising:
a) from about 10% to about 80%, by weight, a non-aqueous organic solvent system;
b) from about 5% to about 70%, by weight, sodium tripolyphosphate (STPP);
c) at least about 0.00005%, by weight, a water-soluble dye;
d) an effective amount of water;
e) from about 0.5% to about 1%, by weight, a thickener; and
f) optionally, an adjunct ingredient;
wherein said composition is in the form of an anhydrous liquid gel; wherein the yield value of said composition has a range of from about 10 to about 20; wherein said water-soluble dye is selected from the group consisting of azo dye, stilbene dye, phthalocyanine dye, triphenodioxazine dye, formazan dye, anthraquinone dye, and mixtures thereof; and wherein the effective amount of water is calculated by the following formula:
STPP+6H2O→STPP*6H20.

19. A method according to claim 18, wherein said organic solvent, STPP, and dye have a wash liquor concentration of from about 100 to about 8000 ppm, from about 500 to about 7000 ppm, and from at least about 0.05 ppm respectively.

20. An article of manufacture comprising: (a) a package, (b) instructions for use, and (c) an organic solvent composition suitable for use in automatic dishwashing comprising (i) from about 10% to about 80% by weight of an organic solvent system, ii) from about 5% to about 70% by weight of STPP; at least about 0.00005% by weight of a water-soluble dye; iii) an effective amount of water; iv) optionally, an adjunct ingredient; wherein said composition is in the form of an anhydrous liquid gel.
